(19) United States
(12) Patent Application Publication
(10) Pub. No.: US 2013/0265324 A1
(43) Pub. Date: Oct. 10, 2013

(54) COMPUTING DEVICE AND METHOD FOR MANAGING MEASUREMENT OBJECT

(71) Applicants: CHIH-KUANG CHANG, Tu-Cheng (TW); XIN-YUAN WU, Shenzhen City (CN); ZONG-TAO YANG, Shenzhen City (CN)

(72) Inventors: CHIH-KUANG CHANG, Tu-Cheng (TW); XIN-YUAN WU, Shenzhen City (CN); ZONG-TAO YANG, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/597,285

(22) Filed: Aug. 29, 2012

(30) Foreign Application Priority Data
Apr. 9, 2012 (CN) 201210100797.3

(51) Int. Cl. G09G 5/00

(52) U.S. Cl. 345/619

(57) ABSTRACT

A computing device displays an entire graphic of a measurement object on an interface displayed on a display device, and displays a tree object region on the interface, where the tree object region covers part of the entire graphic. The device redisplays the entire graphic of the measurement object by copying pixel information of the covered part from a memory of the computing device to the tree object region, creates a hierarchical tree object in the tree object region according to information of the measurement object, and stores a name of each node and coordinate information of a region occupied by each node's name into an array. When a cursor points to the tree object region, the device determines a node selected by the cursor by comparing coordinate information of the cursor with the coordinate information stored in the array.

### BACKGROUND

1. Technical Field

The embodiments of the present disclosure relate to computer aided systems and methods, and particularly to a computing device and a method for managing measurement objects.

2. Description of Related Art

In image measuring, a tree data structure is often used to manage measurement elements, such as points, lines, or surfaces, of a measurement object (such as a three-dimensional model of a product). A user may manipulate the tree data structure to manipulate the elements, such as editing or deleting an element of the measurement object. However, at present, the tree data structure and the measurement object are displayed on two independent user interfaces (such as the interfaces 1 and 2 shown in FIG. 1), so that the user needs to switch between the two interfaces.

### BRIEF DESCRIPTION OF THE DRAWINGS

FIG. 1 shows a measurement object and a tree data structure displayed on two independent user interfaces in prior art.

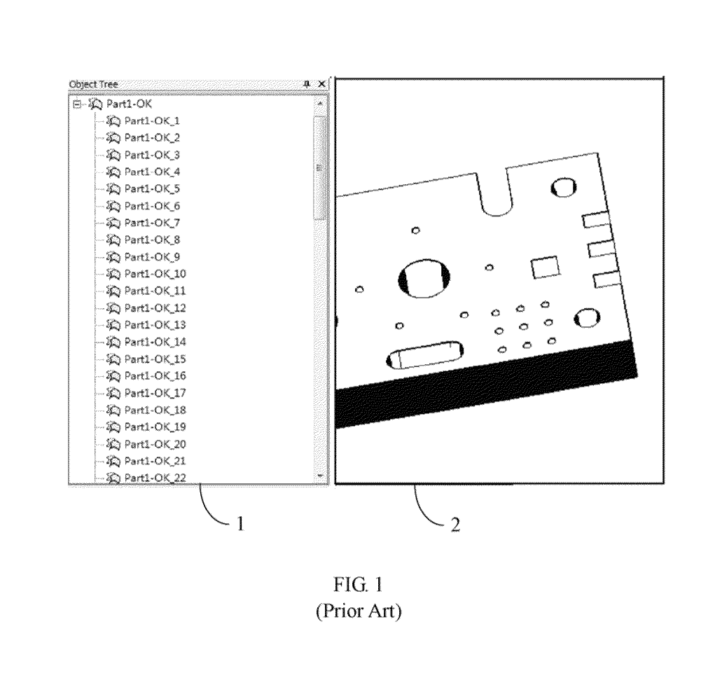

FIG. 2 is a block diagram of one embodiment of function modules of a computing device including a measurement object management unit.

FIG. 3 is a flowchart of one embodiment of a method for managing a measurement object.

FIG. 4 illustrates an entire graphic of a measurement object displayed on a graphic user interface (GUI).

FIG. 5 illustrates creating a tree object region, which covers a portion of the entire graphic of the measurement object, on the GUI shown in FIG. 4.

FIG. 6 illustrates redisplaying the entire graphic of the measurement object on the GUI.

FIG. 7 illustrates creating a hierarchical tree list in the tree object region for managing the measurement object shown in FIG. 6.

### DETAILED DESCRIPTION

The disclosure, including the accompanying drawings, is illustrated by way of examples and not by way of limitation. It should be noted that references to “an” or “one” embodiment in this disclosure are not necessarily to the same embodiment, and such references mean “at least one.”

In general, the word “module”, as used herein, refers to logic embodied in hardware or firmware, or to a collection of software instructions, written in a programming language. One or more software instructions in the modules may be embedded in firmware, such as in an erasable programming read only memory (EPROM).

The modules described herein may be implemented as either software and/or hardware modules and may be stored in any type of non-transitory computer-readable medium or other storage device. Some non-limiting examples of non-transitory computer-readable media include CDs, DVDs, BLU-RAY, flash memory, and hard disk drives.

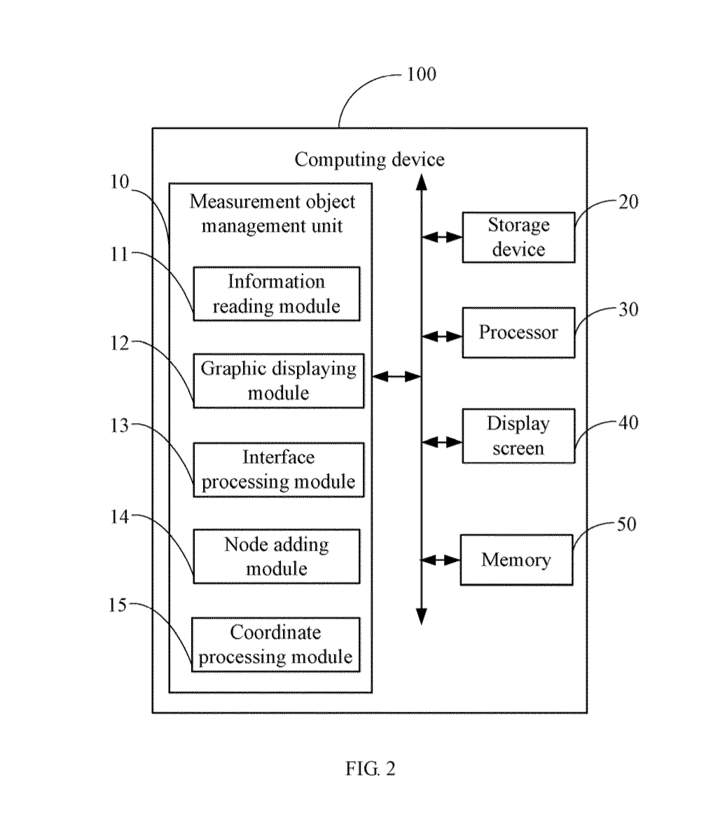

FIG. 2 is a block diagram of one embodiment of function modules of a computing device 100. The computing device 100 includes a measurement object management unit 10, a storage device 20, a processor 30, a display screen 40, and a memory 50. The components 10-50 communicate with each other via a bus. One of ordinary skill in the art would understand that the computing device 100 may include other or different components.

The storage device 20 stores information related to the measurement object. The information related to the measurement object includes a name of the measurement object, names of measurement elements of the measurement object, and parameters of the measurement elements. The measurement elements may include, but are not limited to, points, lines, and surfaces. The parameters of each measurement element include coordinate information of the measurement element in a coordinate system (such as a machine coordinate system) and dimensional data of the measurement element. For example, if the measurement element is a circle, the parameters may include coordinate information of a center point of the circle and a radius of the circle.

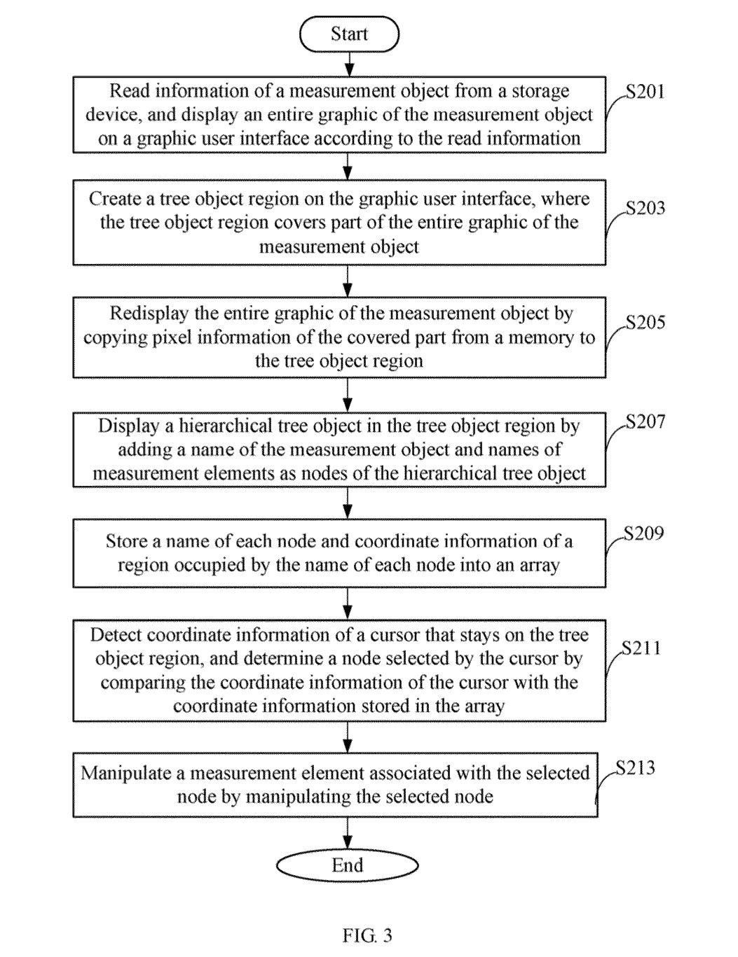

As shown in FIG. 2, the measurement object management unit 10 includes an information reading module 11, a graphic displaying module 12, an interface processing module 13, a node adding module 14, and a coordinate processing module 15. The modules 11-15 include computerized code in the form of one or more programs that are stored in the storage device 20. The processor 30 executes the computerized code to integrate the measurement object and the tree object in the same user interface. A detailed description of the modules 11-15 refers to below descriptions regarding FIG. 3

FIG. 3 is a flowchart of one embodiment of a method for managing a measurement object. Depending on the embodiment, additional steps may be added, others removed, and the ordering of the steps may be changed.

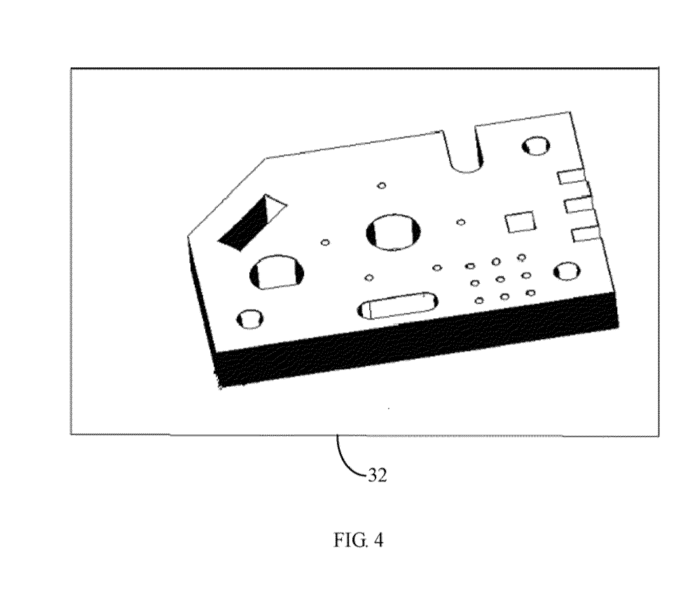

In step S201, the information reading module 11 reads information of a measurement object from the storage device 20. In one embodiment, the measurement object is a three-dimensional model of a product. As mentioned above, the information related to the measurement object includes a name of the measurement object, names of measurement elements of the measurement object, and parameters of the measurement elements. The measurement elements may include, but are not limited to, points, lines, and surfaces. The graphic displaying module 12 displays an entire graphic of the measurement object on a graphic user interface (GUI) according to the read information. For example, in FIG. 4, the GUI 32 displays the entire graphic of the measurement object. Pixel information of the entire graphic of the measurement object is stored in the memory 50. The pixel information includes a number of pixels of the entire graphic, position information/coordinate information and a gray value of each pixel, for example. It should be understood that displaying the entire graphic of the measurement object on the GUI may involve only displaying a visible portion of the measurement object on the GUI, where other non-visible portions may become visible by appropriate manipulation of an input device, such as scrolling through the entire graphic.

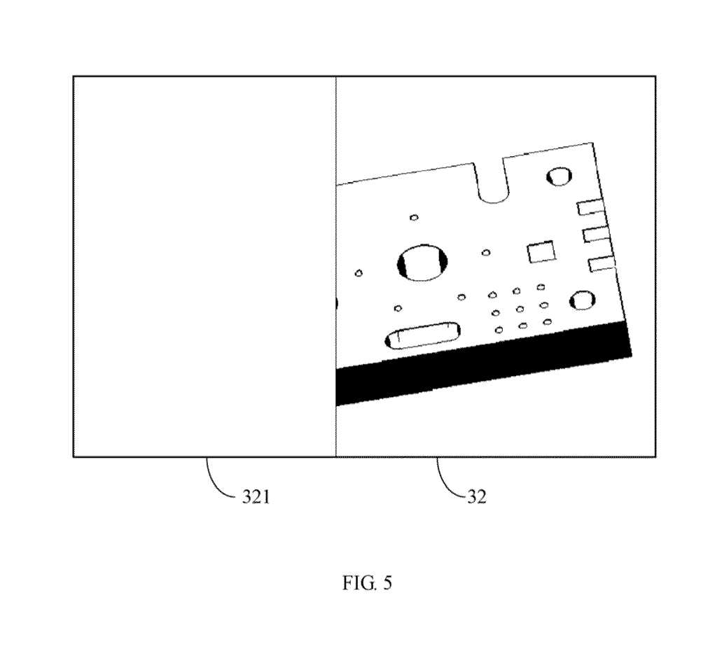

In step S203, the interface processing module 13 creates a tree object region on the GUI, where the tree object region covers part of the entire graphic of the measurement object. For example, as shown in FIG. 5, the tree object region 321 created in the GUI 32 covers part of the entire graphic of the measurement object. The tree object region is for displaying a tree object.

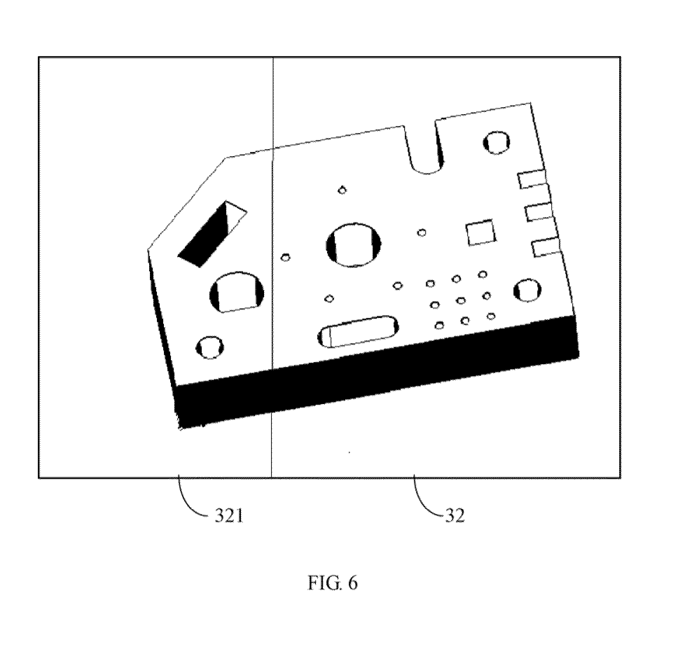

In step S205, the interface processing module 13 redisplays the entire graphic of the measurement object by copying pixel information of the covered part from the memory 50 to the tree object region. As shown in FIG. 6, the part of the entire graphic that is covered by the tree object region 321 in FIG. 5 is displayed in the tree object region 321, so that the entire graphic of the measurement object is displayed again.

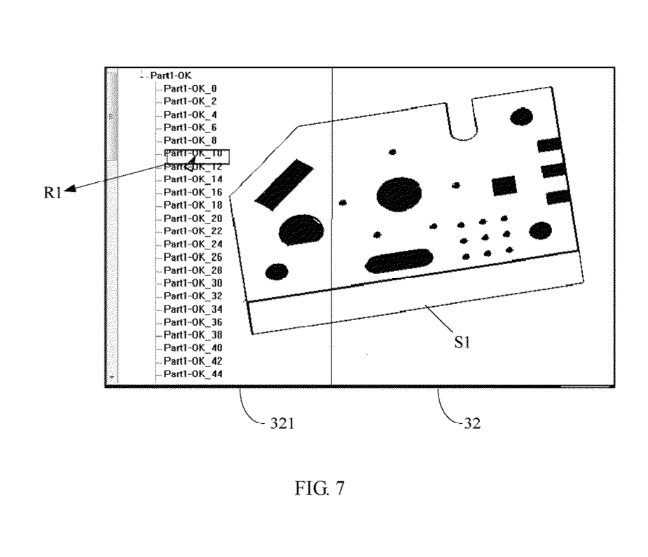

In step S207, the node adding module 14 displays a hierarchical tree object in the tree object region by adding the name of the measurement object and names of the measurement elements as nodes of the hierarchical tree object. For example, if the name of the measurement object is “Part1-OK,” and the measurement object “Part1-OK” has measurement elements named from “Part1-OK-0” to “Part1-OK-44,” the node adding module 14 adds the name of “Part1-OK” as a root node of the hierarchical tree object, and adds the names ranged from “Part1-0K-0” to “Part1-OK-44” as sub-nodes of the root node, so as to create the hierarchical tree object shown in the tree object region 321 in FIG. 7.

In step S209, the coordinate processing module 15 stores a name of each node and coordinate information of a region occupied by the name of each node into an array. For example, as shown in FIG. 7, R1 represents a rectangular region occupied by a name of a node “Part1-OK-10,” the coordinate processing module 15 stores coordinate information of the rectangular region R1. For example, if coordinate data of a left-bottom vertex of the rectangular region R1 is (170, 173), and coordinate data of an upper-right vertex of the rectangular region R1 is (230, 183), the coordinate processing module 15 may store the coordinate data as an element in a form of (170, 173, 230, 183) in the array.

In step S211, the coordinate processing module 15 detects coordinate information of a cursor (e.g., of a mouse or a pointing device) that stays on the tree object region, and determines a node selected by the cursor by comparing the coordinate information of the cursor with the coordinate information stored in the array. For example, as shown in FIG. 7, if coordinate data of the cursor is (200, 178), the coordinate processing module 15 compares the coordinate data (200, 178) with elements stored in the array one by one, and determines that the coordinate data (200, 178) falls within the rectangular region R1 with the coordinate data of (170, 173, 230, 183). Thus, the cursor is determined as pointing to the node “Part1-OK-10.”

In step S213, manipulating the selected node to manipulate an associated measurement element on the entire graphic of the measurement object. For example, as shown in FIG. 7, if the node “Part1-0K-10” of hierarchical tree object displayed in the tree object region 321 is associated with a surface S1 of the measurement object displayed in the GUI 32, the user can manipulate the selected node “Part1-OK-10” to manipulate the surface S1, such as deleting the surface S1, or adjusting parameters of the surface S1.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A computing device comprising:
a processor;
a storage device; and
one or more programs stored in the storage device and executed by the processor to perform a method, the method comprising:
reading information of a measurement object from the storage device, and displaying an entire graphic of the measurement object on a graphic user interface (GUI) displayed on a display device according to the read information;
displaying a tree object region on the GUI, wherein the tree object region covers part of the entire graphic of the measurement object;
redisplaying the entire graphic of the measurement object by copying pixel information of the covered part from a memory of the computing device to the tree object region;
creating a hierarchical tree object in the tree object region by adding a name of the measurement object and names of measurement elements of the measurement object as nodes of the hierarchical tree object;
storing a name of each node and coordinate information of a region occupied by the name of each node into an array; and
detecting coordinate information of a cursor that stays on the tree object region, and determining a node selected by the cursor by comparing the coordinate information of the cursor with the coordinate information stored in the array.

2. The device of claim 1, wherein the method further comprises:
manipulating the selected node to manipulate an associated measurement element on the entire graphic of the measurement object displayed on the GUI.

3. The device of claim 1, wherein the information related to the measurement object comprises the name of the measurement object, the names of measurement elements of the measurement object, and parameters of the measurement elements.

4. The device of claim 1, wherein the pixel information of the entire graphic of the measurement object is stored in the memory when the entire graphic is displayed, and the pixel information comprises a number of pixels of the entire graphic, position information and a gray value of each of the pixels.

5. A method being executed by a processor of a computing device for managing a measurement object, the method comprising:
reading information of the measurement object from a storage device, and displaying an entire graphic of the measurement object on a graphic user interface (GUI) displayed on a display device according to the read information;
displaying a tree object region on the GUI, wherein the tree object region covers part of the entire graphic of the measurement object;
redisplaying the entire graphic of the measurement object by copying pixel information of the covered part from a memory of the computing device to the tree object region;
creating a hierarchical tree object in the tree object region by adding a name of the measurement object and names of measurement elements of the measurement object as nodes of the hierarchical tree object;
storing a name of each node and coordinate information of a region occupied by the name of each node into an array; and
detecting coordinate information of a cursor that stays on the tree object region, and determining a node selected by the cursor by comparing the coordinate information of the cursor with the coordinate information stored in the array.

6. The method of claim 5, further comprising:
manipulating the selected node to manipulate an associated measurement element on the entire graphic of the measurement object displayed on the GUI.

7. The method of claim 5, wherein the information related to the measurement object comprises the name of the measurement object, the names of measurement elements of the measurement object, and parameters of the measurement elements.

8. The method of claim 5, wherein the pixel information of the entire graphic of the measurement object is stored in the memory when the entire graphic is displayed, and the pixel information comprises a number of pixels of the entire graphic, position information and a gray value of each of the pixels.

9. A non-transitory computer-readable medium storing a set of instructions, the set of instructions capable of being executed by a processor of a computing device to perform a method for managing a measurement object, the method comprising:
reading information of the measurement object from a storage device, and displaying an entire graphic of the measurement object on a graphic user interface (GUI) displayed on a display device according to the read information;
displaying a tree object region on the GUI, wherein the tree object region covers part of the entire graphic of the measurement object;
redisplaying the entire graphic of the measurement object by copying pixel information of the covered part from a memory of the computing device to the tree object region;
creating a hierarchical tree object in the tree object region by adding a name of the measurement object and names of measurement elements of the measurement object as nodes of the hierarchical tree object;
storing a name of each node and coordinate information of a region occupied by the name of each node into an array; and
detecting coordinate information of a cursor that stays on the tree object region, and determining a node selected by the cursor by comparing the coordinate information of the cursor with the coordinate information stored in the array.

10. The medium of claim 9, wherein the method further comprises:
manipulating the selected node to manipulate an associated measurement element on the entire graphic of the measurement object displayed on the GUI.

11. The medium of claim 9, wherein the information related to the measurement object comprises the name of the measurement object, the names of measurement elements of the measurement object, and parameters of the measurement elements.

12. The medium of claim 9, wherein the pixel information of the entire graphic of the measurement object is stored in the memory when the entire graphic is displayed, and the pixel information comprises a number of pixels of the entire graphic, position information and a gray value of each of the pixels.
